(19) United States
(12) Patent Application Publication
(10) Pub. No.: US 2006/0031655 A1
(43) Pub. Date: Feb. 9, 2006

(54) Computer readable storage medium and semiconductor integrated circuit device

(75) Inventors: Kei Kato, Tokyo (JP); Masanao Yamaoka, Hachioji (JP); Keiichi Higeta, Hamura (JP); Kazumasa Yanagisawa, Kokubunji (JP); Shigeru Shimada, Nishitokyo (JP); Kodo Yamauchi, Fukuoka (JP); Yoshihiro Shinozaki, Fukuoka (JP); Yasuo Taguchi, Ome (JP)

Correspondence Address: MILES & STOCKBRIDGE PC, 1751 PINNACLE DRIVE, SUITE 500, MCLEAN, VA, 22102-3833, US

(73) Assignees: Renesas Technology Corp.; Hitachi ULSI Systems Co., Ltd.

(21) Appl. No.: 11/242,854

(22) Filed: Oct. 5, 2005

Related U.S. Application Data
(63) Continuation of application No. 10/330,358, filed on Dec. 30, 2002.

(30) Foreign Application Priority Data
Jan. 25, 2002 (JP) 2002-016410

(51) Int. Cl. G06F 12/00

(52) U.S. Cl. 711/170; 711/101

(57) ABSTRACT

The present invention is directed to facilitate change in the specifications of an interface of a memory IP and to improve reusability of the memory IP. A memory module to be mounted on a system LSI or the like is constructed by a basic array and an interface. The basic array is constructed by direct peripheral circuits and a storage circuit. Library data of the basic array is stored in a storage medium such as a CD-R or a magnetic tape and distributed to the user. The library data includes layout pattern data, a logic simulation model defining the operation of the basic array, LSI pattern information such as a layout, device information such as characteristics of a MOS device and layout rules, interface information such as various signal timings, and device specification data such as terminal information.

### BACKGROUND OF THE INVENTION

The present invention relates to a computer readable storage medium and a semiconductor integrated circuit device and, more particularly, to a technique effectively applied to reuse of a memory IP (Intellectual Property).

As a semiconductor integrated circuit device constructed by combining various IPs, a so-called system LSI is widely known.

In the system LSI, a clock synchronous memory such as an SRAM (Static Random Access Memory) is often mounted as a memory IP. The specifications of a memory interface are also simple so as not to be influenced by a use form of the user.

A technique of designing a semiconductor integrated circuit device using an IP of this kind is specifically described in, for example, Japanese Unexamined Patent Application No. 2001-142923 and a method of automatically generating an interface circuit of two IP cores is described in the literature.

### SUMMARY OF THE INVENTION

However, the inventor herein has found that such a memory IP mounted on a system LSI has problems as follows.

In recent years, a demand for customizing a memory IP is increasing in the system LSI. The demand is, for example, improvement in matching with a CPU core and improvement in security.

In the case of increasing matching with a CPU core, an interface of a memory IP has to be improved and it causes a problem such that cost increases and so on. To improve security, a countermeasure of scrambling a decoder so that memory data is not read by encoding or decoding of a memory address. There is a problem that such a countermeasure for security has not been taken.

An object of the invention is to provide a computer readable storage medium and a semiconductor integrated circuit device in which the specifications of an interface of a memory IP can be easily changed and reusability of a memory IP is improved.

The above and other objects and novel features of the present invention will become apparent from the following description of the specification and the accompanying drawings.

Outlines of representative ones of inventions disclosed in the specification will be briefly described as follows.
1. A computer readable storage medium storing a hard IP having layout pattern data of a basic array including a semiconductor memory and device specification data of the basic array.
2. In the computer readable storage medium of the item (1), the device specification data includes a logic simulation model defining operation of the basic array, a layout pattern, device information, interface information, and terminal information.
3. In the computer readable storage medium of the item (1) or (2), the basic array includes a storage circuit and direct peripheral circuits of the storage circuit, and a decoded signal is input to the direct peripheral circuits.
4. In the computer readable storage medium of the item (1), (2), or (3), the basic array operates asynchronously with a clock signal and has a monitor control unit for controlling an interface connected between the basic array and control means for controlling the basic array by a monitor signal.
5. In the computer readable storage medium of the item (4), monitor signals output from the monitor control unit are constituted of a first monitor signal which is output in a reading operation from a read/write circuit provided to the direct peripheral circuit and a second monitor signal which is output in a reading operation from a word selection circuit provided to the direct peripheral circuit.

Outlines of the other inventions of the specification will be also briefly described.
6. A semiconductor integrated circuit device including: two or more basic arrays each including a storage circuit and direct peripheral circuits of the storage circuit and taking the form of a hard IP; and a primitive provided as an interface of each of the basic arrays.
7. In the semiconductor integrated circuit device of the item (6), a decoded signal output from the primitive is input to the basic array.
8. In the semiconductor integrated circuit device of the item (6) or (7), the basic array operates asynchronously with a clock signal and has a monitor control unit for controlling the primitive by a monitor signal.
9. In the semiconductor integrated circuit device of the item (8), monitor signals output from the monitor control unit are constituted of a first monitor signal which is output in a reading operation from a read/write circuit provided to the direct peripheral circuit and a second monitor signal which is output in a reading operation from a word selection circuit provided to the direct peripheral circuit.

### BRIEF DESCRIPTION OF THE DRAWINGS

FIG. 1 is a block diagram of a memory module according to an embodiment of the invention.

FIG. 2 is a block diagram showing a case where a basic array according to the embodiment of the invention is connected to a CPU core.

FIG. 3 is a diagram for explaining a case of using an interface constructed by a soft macro module to the basic array in FIG. 2.

FIG. 4 is a diagram for explaining a detailed connection configuration of the basic array and the interface in FIG. 3.

FIG. 5 is a timing chart of signals used in the case where the basic array shown in FIG. 4 controls a latch circuit by monitor signals.

FIG. 6 is an explanatory diagram showing an example of the case of changing the design of a decoding circuit of the interface in FIG. 4 to improve security.

FIG. 7 is a block diagram showing an example of a memory module for changing the specification of address assignment in FIG. 6.

FIG. 8 is an explanatory diagram of a re-use condition at the time of mounting the basic array in FIG. 4 on a different system LSI.

FIG. 9 is an explanatory diagram of a different system LSI re-using the basic array under the re-use condition of FIG. 8.

FIG. 10 is a flowchart in a form of releasing library data in the basic array 2 in FIG. 4.

FIG. 11 is an explanatory diagram of a basic array provided as a library and a CRAM constructed by using the basic array.

FIG. 12 is an explanatory diagram showing an example of definition of a monitor signal terminal of a logic simulation model in library data in the basic array 2.

FIG. 13 is an explanatory diagram showing an example of description of a monitor signal in the logic simulation model in library data in the basic array 2.

FIG. 14 is an explanatory diagram showing an example of wire connection of a memory module using the basic array in the logic simulation model in FIGS. 12 and 13.

FIG. 15 is a timing chart showing signal waveforms in the wire-connected memory module in FIG. 14.

### DETAILED DESCRIPTION OF THE PREFERRED EMBODIMENT

An embodiment of the invention will be described in detail hereinbelow with reference to the drawings.

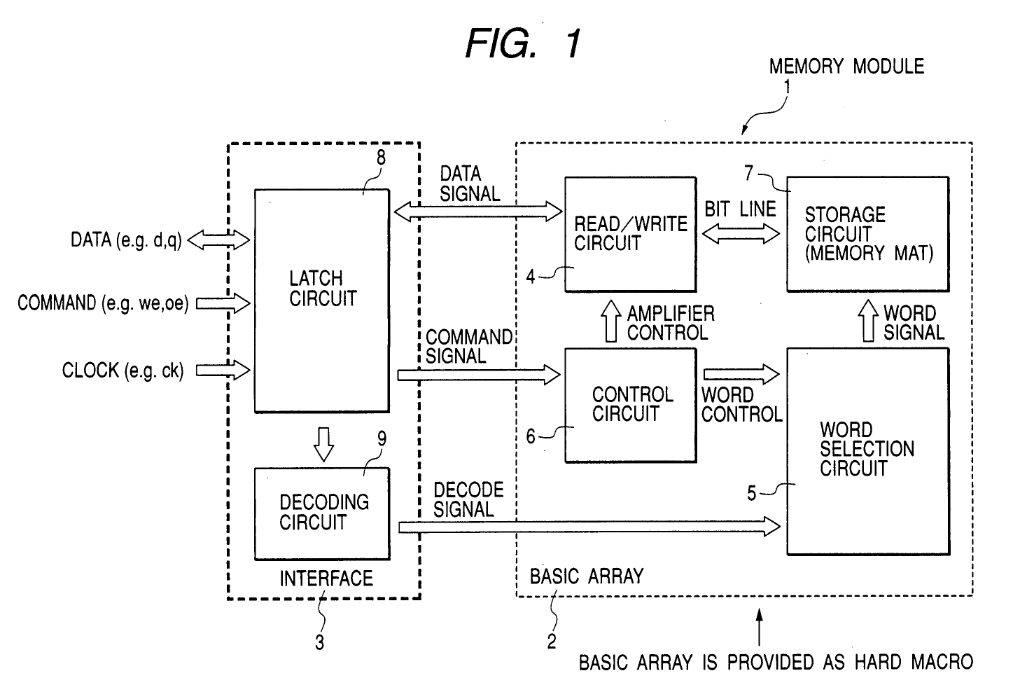

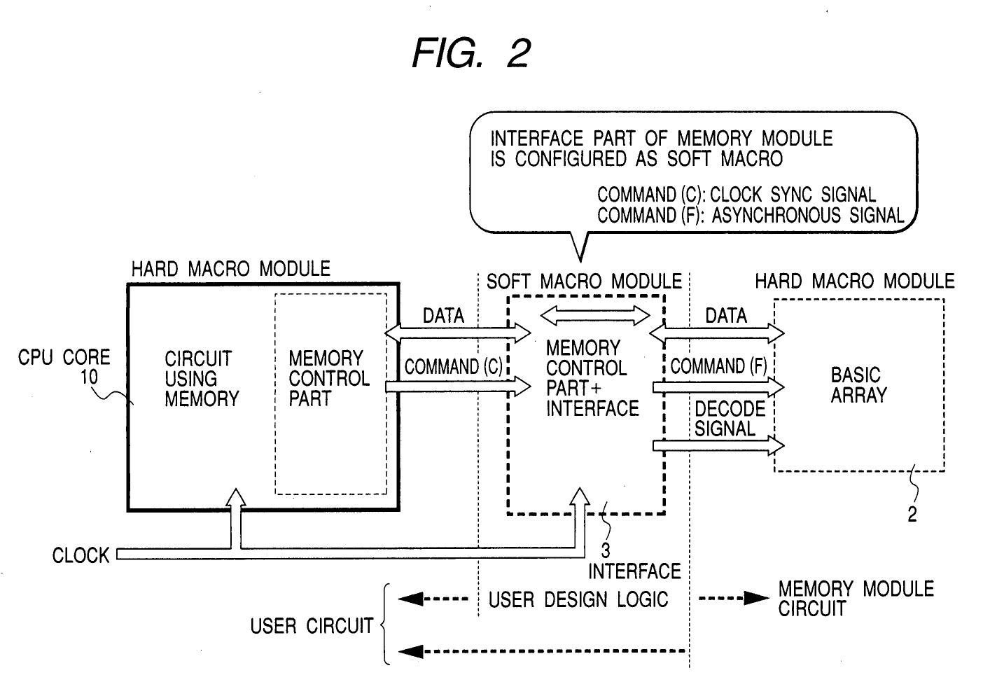

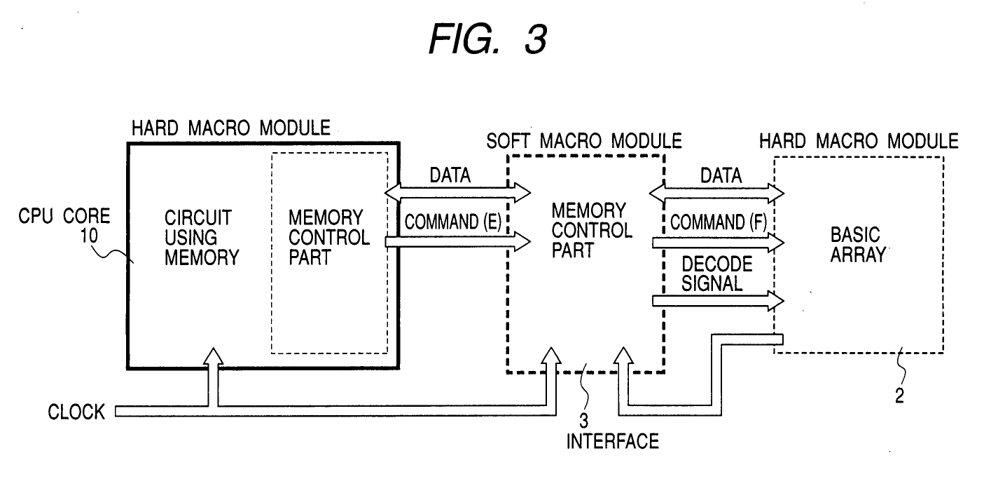

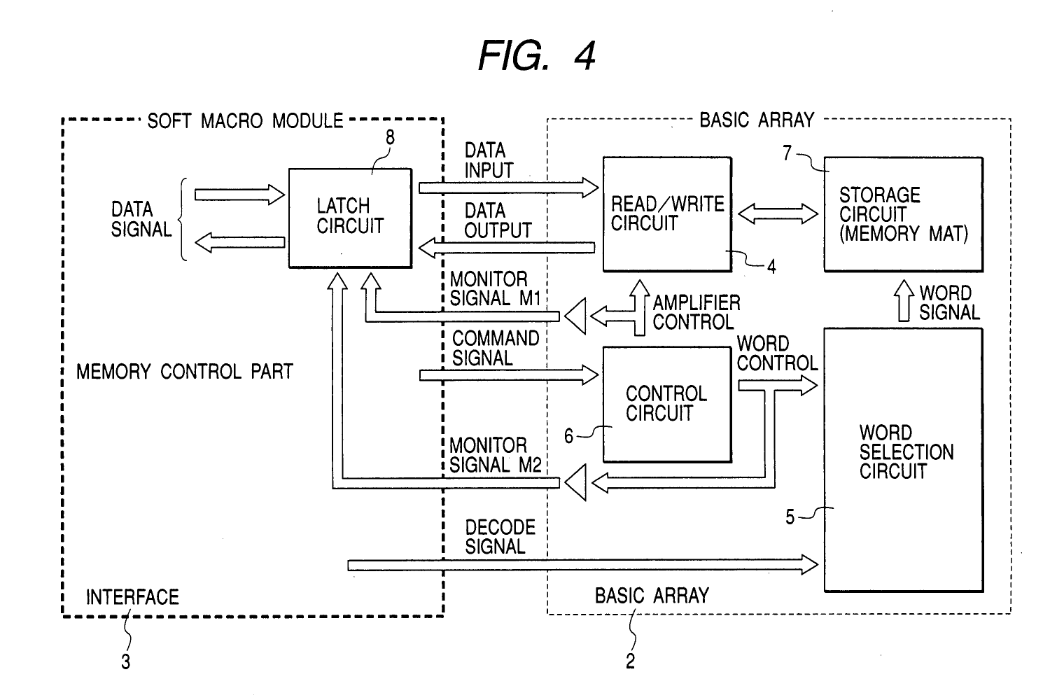

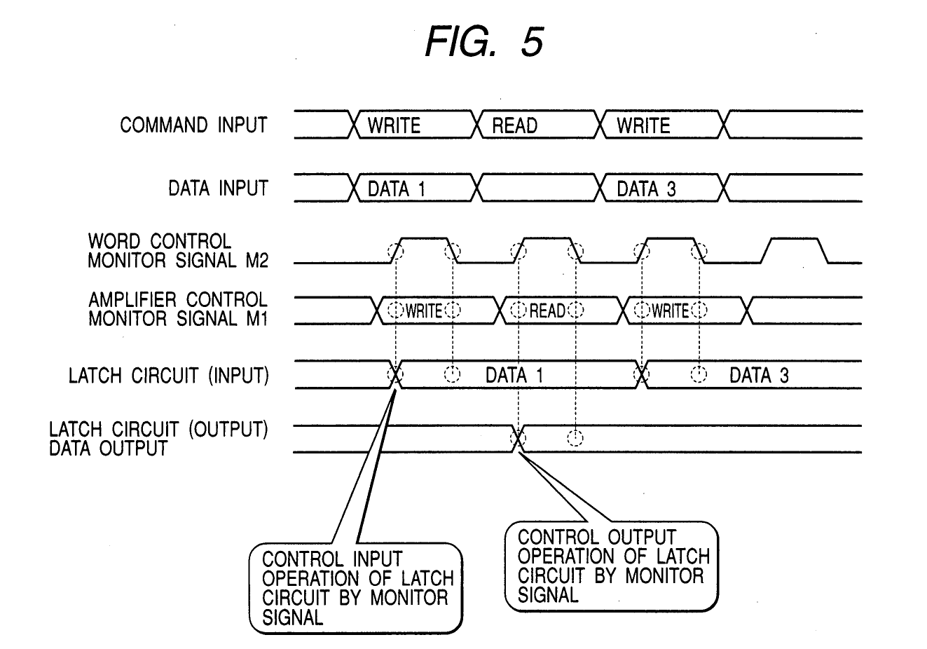

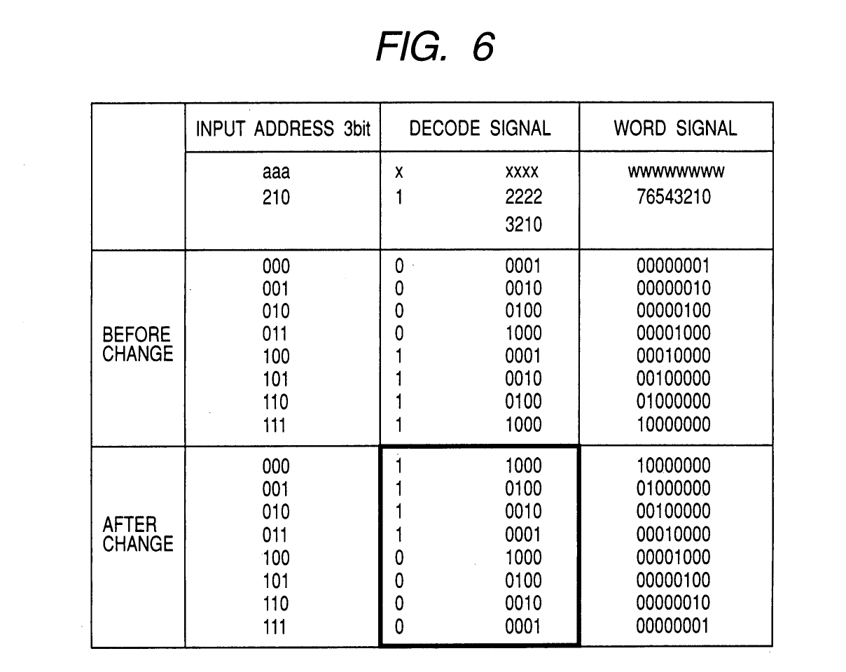

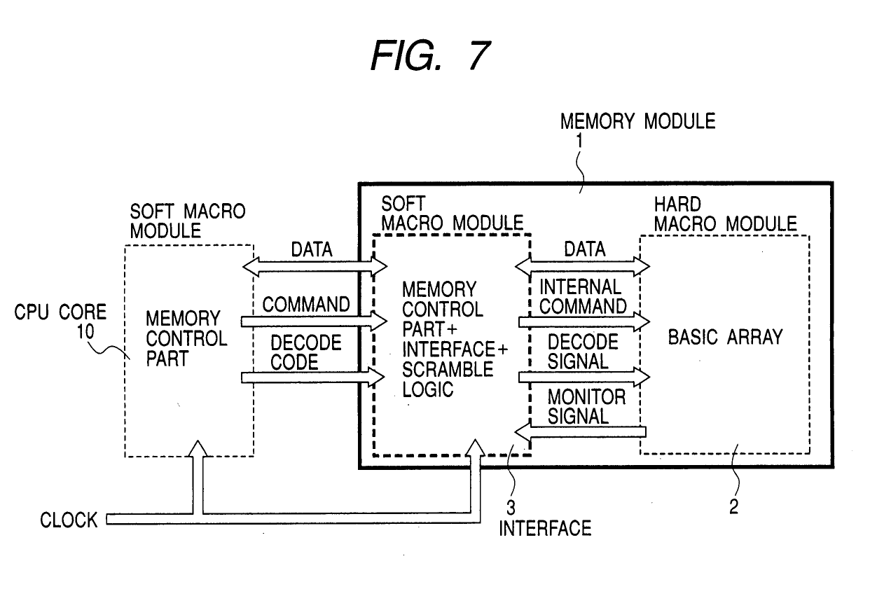

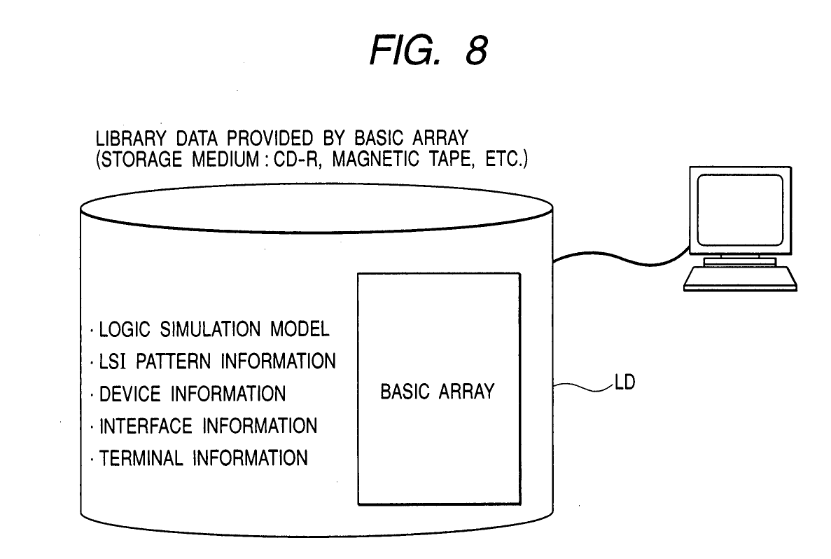

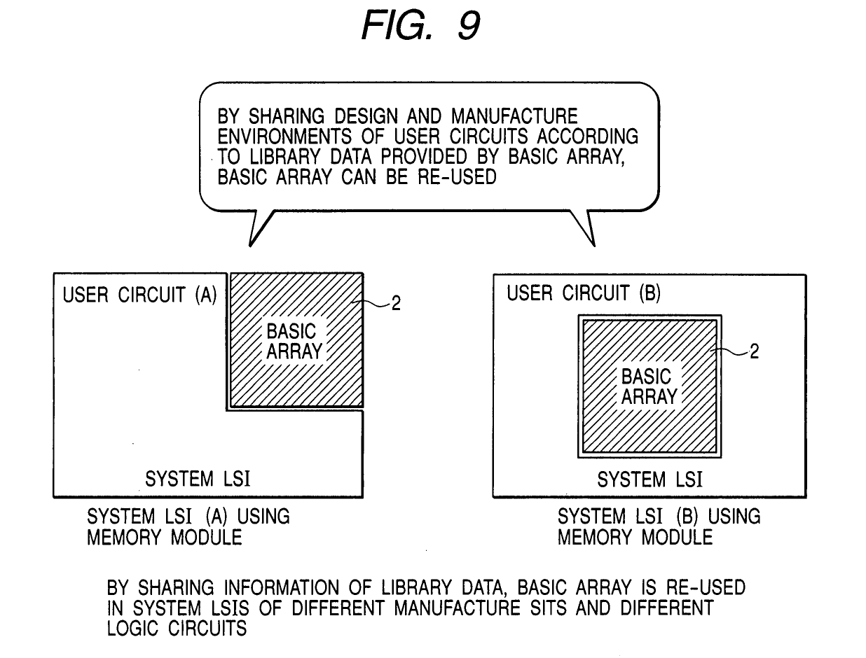

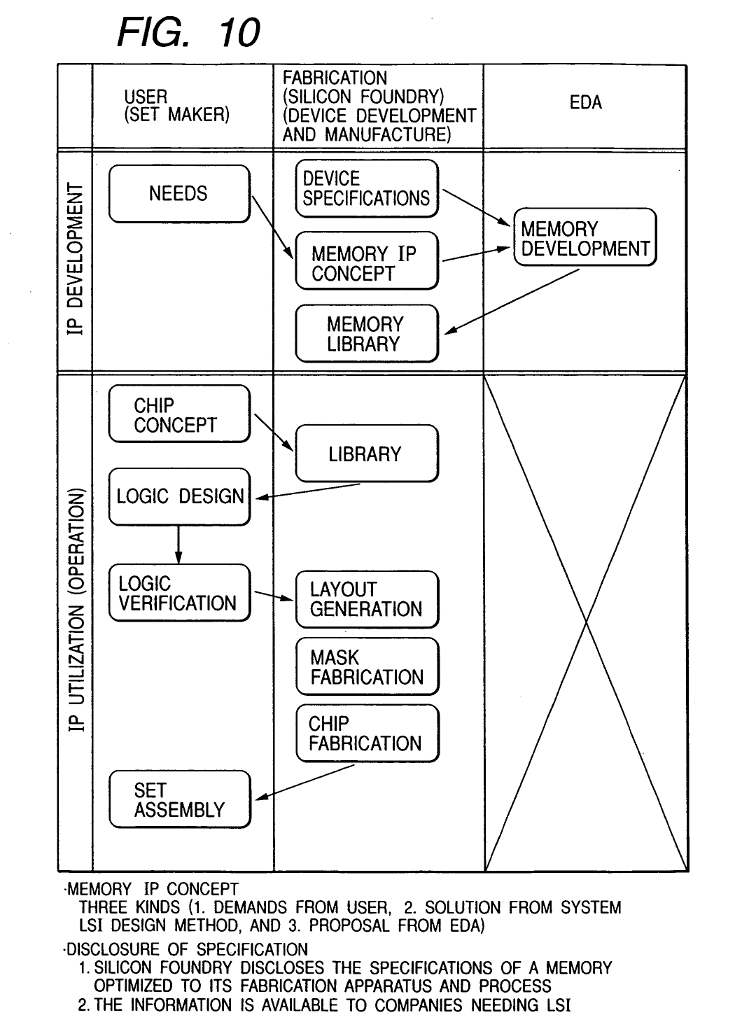

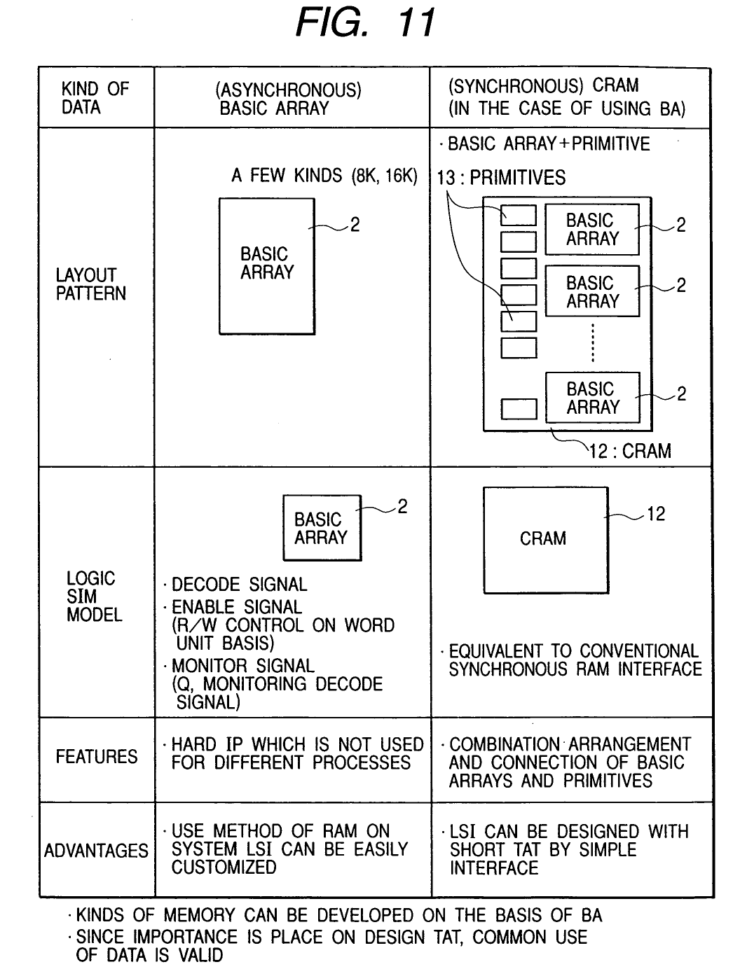

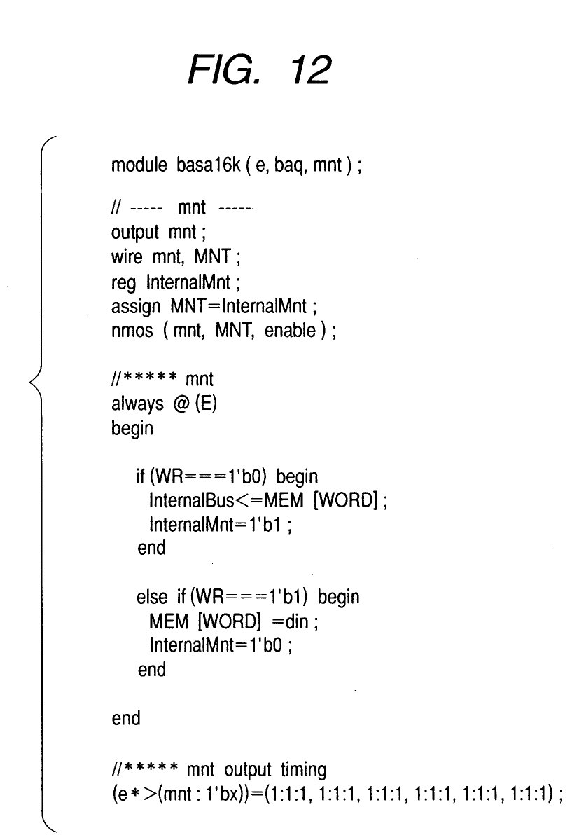

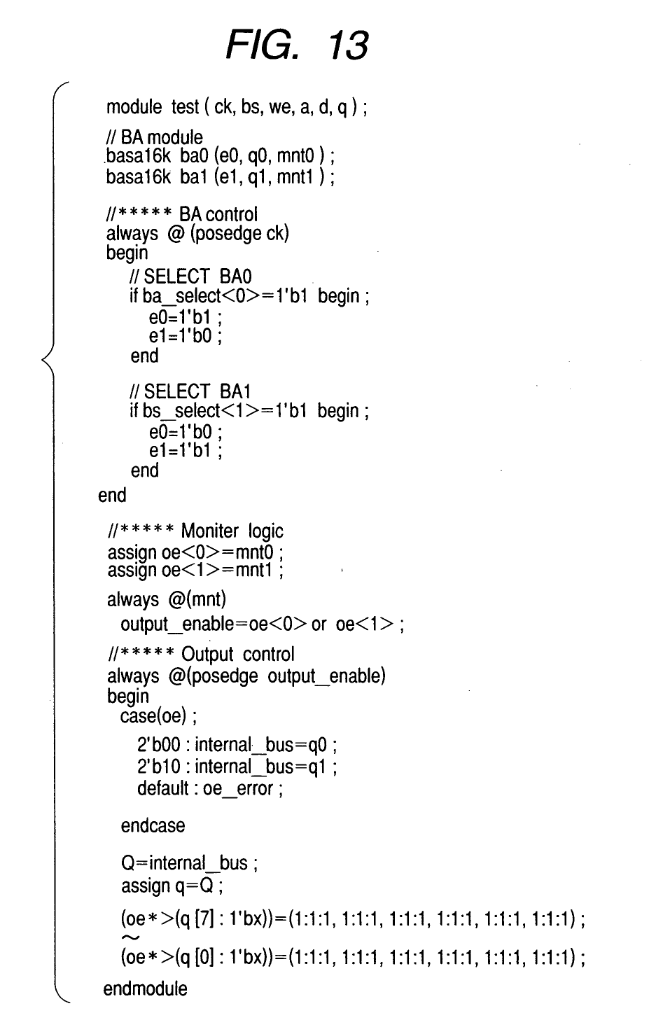

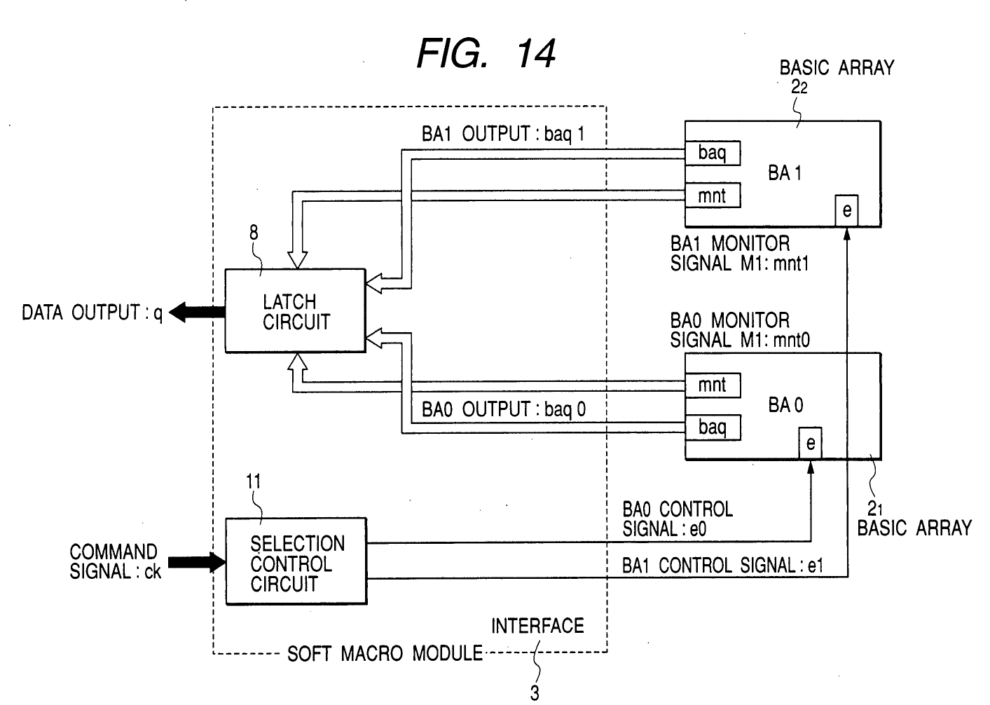

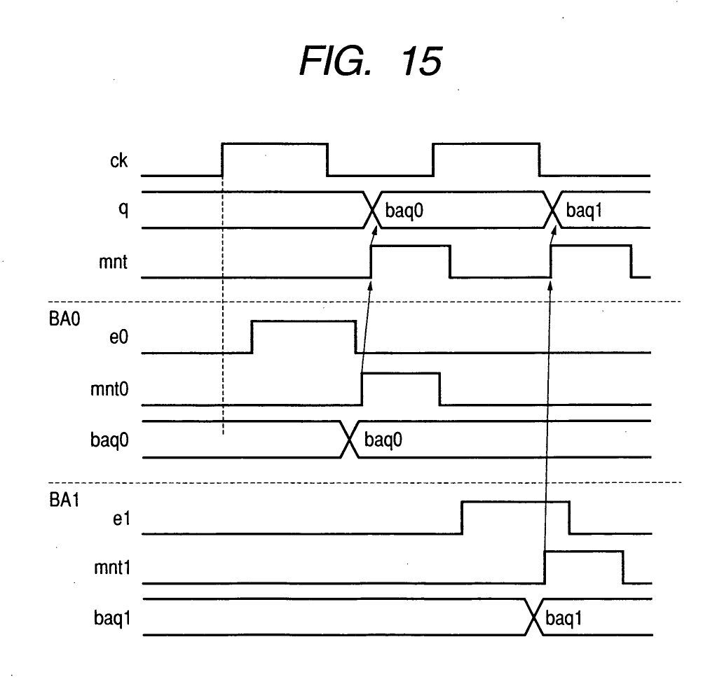

FIG. 1 is a block diagram of a memory module according to an embodiment of the invention. FIG. 2 is a block diagram showing a case where a basic array according to the embodiment of the invention is connected to a CPU core. FIG. 3 is a diagram for explaining a case of using an interface constructed by a soft macro module to the basic array in FIG. 2. FIG. 4 is a diagram for explaining a detailed connection configuration of the basic array and the interface in FIG. 3. FIG. 5 is a timing chart of signals used in the case where the basic array shown in FIG. 4 controls a latch circuit by monitor signals. FIG. 6 is an explanatory diagram showing an example of the case of changing the design of a decoding circuit of the interface in FIG. 4 to improve security. FIG. 7 is a block diagram showing an example of a memory module for changing the specification of address assignment in FIG. 6. FIG. 8 is an explanatory diagram of re-use conditions at the time of mounting the basic array in FIG. 4 on a different system LSI. FIG. 9 is an explanatory diagram of a different system LSI re-using the basic array under the re-use conditions of FIG. 8. FIG. 10 is a flowchart in a form of releasing library data in the basic array 2 in FIG. 4. FIG. 11 is an explanatory diagram of a basic array provided as a library and a CRAM constructed by using the basic array. FIG. 12 is an explanatory diagram showing an example of definition of a monitor signal terminal of a logic simulation model in library data in the basic array 2. FIG. 13 is an explanatory diagram showing an example of description of a monitor signal in the logic simulation model in library data in the basic array 2. FIG. 14 is an explanatory diagram showing an example of wire connection of a memory module using the basic array in the logic simulation model in FIGS. 12 and 13. FIG. 15 is a timing chart showing signal waveforms in the wire-connected memory module in FIG. 14.

In the embodiment, a memory module 1 is, for example, an SRAM module which is mounted on a system LSI or the like. As shown in FIG. 1, the memory module 1 is constructed by a basic array 2 and an interface 3.

The basic array 2 is constructed by direct peripheral circuits of a read/write circuit 4, a word selection circuit 5, and a control circuit (monitor control unit) 6, and a storage circuit 7.

The read/write circuit 4 has, at least, the reading function and is constructed by a sense amplifier for amplifying a cell read signal of a memory cell, a column decoder for selecting a bit line in the column direction and supplying a selective pulse voltage to the selected bit line, and the like.

The word selection circuit 5 is constructed by a row decoder for selecting a word line in the row direction in the storage circuit and applying a selective pulse voltage to the selected word line, and the like. The control circuit 6 receives a command signal and controls the read/write circuit 4, word selection circuit 5, and the like. The storage circuit 7 takes the form of a memory mat in which memory cells as minimum units of storage are regularly arranged in an array.

Further, the interface 3 is constructed by a latch circuit 8, a decoding circuit 9, and the like. To the latch circuit 8, data, a clock signal, and commands such as an address signal, a write enable signal, an output enable signal, and a chip select signal are input.

The decoding circuit 9 decodes the address signal received via the latch circuit 8 and outputs the result as a decoded signal to the word selection circuit 5.

In the memory module 1 of such a configuration, the basic array 2 is a hard IP and the interface 3 is a user circuit which is a logic circuit designed by the user.

FIG. 2 shows a system configuration in which the basic array 2 is connected to a CPU core (control means) 10.

The basic array 2 is connected to the CPU core 10 via the interface 3. The interface 3 is constructed by a design logic (hereinafter referred to as a soft macro module) described in the HDL (Hardware Description Language) or the like as a programming language used for designing of a semiconductor device, and the CPU core 10 is a hardware module, that is, a hard macro module.

From the CPU core 10, data and commands such as the address signal, write enable signal, output enable signal, and chip select signal are input/output from/to the interface 3 synchronously with clock signals.

From the interface 3, the data, command, and a decoded signal obtained by decoding the address signal are input/output from/to the basic array 2 asynchronously with the clocks.

Therefore, by constructing the interface 3 as the user circuit taking the form of the soft macro module, a circuit change or the like due to variations in the interface of the basic array 2, CPU core 10, and the like is made unnecessary.

In the case of using the interface 3 taking the form of the soft macro module, as shown in FIG. 3, the interface 3 can be also controlled by using a monitor signal output from the basic array 2.

FIG. 4 shows a detailed connection configuration of the basic array 2 and the interface 3 in this case. As shown in the diagram, from the control circuit 6, monitor signals M1 and M2 are output to the latch circuit 8 in the interface 3. The latch circuit 8 latches data on the basis of the monitor signals M1 and M2.

The monitor signal (first monitor signal) M1 is a control signal of a sense amplifier provided for the read/write circuit 4 output from the control circuit 6. The monitor signal (second monitor signal) M2 is a control signal of the word selection circuit 5 similarly output from the control circuit 6.

FIG. 5 is a timing chart of signals used at the time of controlling the latch circuit 8 by the monitor signals M1 and M2. FIG. 5 shows, in order from top to down, timings of commands and data output from the interface 3, the monitor signals M1 and M2 output from the control circuit 6, data input to the latch circuit 8, and data output from the latch circuit 8.

First, when a write command is input to the control circuit 6, data is input to the read/write circuit 4. The control circuit 6 receives the write command and outputs a control signal for performing a writing operation to the sense amplifier. The control signal is output as the monitor signal M2 to the latch circuit 8.

The control circuit 6 also outputs a control signal for performing the writing operation to the word selection circuit 5. The control signal is output as the monitor signal M1 to the latch circuit 8. The latch circuit 8 determines that the operation is the writing operation from the input monitor signals M1 and M2 and latches the input data.

On the other hand, in the case of the reading operation, a read command is input to the control circuit 6. The control circuit 6 receives the read command, outputs a control signal for performing the reading operation to the sense amplifier, and also outputs a control signal for performing the reading operation to the word selection circuit 5. The control signals are output as monitor signals M1 and M2 to the latch circuit 8.

The latch circuit 8 determines that the operation is the reading operation from the input monitor signals M1 and M2 and outputs data read from the storage circuit 7 via the read/write circuit 4.

As described above, in the case of controlling the interface 3 by using the monitor signals M1 and M2, when two or more (a plurality of) basis arrays 2 are connected to one interface 3, the basic array 2 which is operating can be specified, so that the connection configuration is particularly effective.

In the interface 3 of the soft macro module, the design of the decoding circuit 9 can be easily changed, so that data security can be easily improved.

For example, in the upper part of FIG. 6, specifications of address assignment in the case where the design of the decoding circuit 8 is not changed are shown. In the lower part of FIG. 6, an example of the case where the design of the decoding circuit 9 is changed, the decoded signal is changed, thereby changing the word selection signal, and the specifications of assignment of addresses are changed to improve the security is shown.

FIG. 7 shows an example of the memory module 1 for changing the specifications of address assignment shown in the lower part of FIG. 6. As shown in the diagram, by adding a scramble logic to the interface 3 taking the form of a soft macro module, the security function can be provided easily.

For example, by using the memory module 1 having the configuration of FIG. 7 for an IC card or the like, high security can be realized, and reliability of an electronic system such as the IC card can be improved.

Further, in the case of mounting the basic array 2 on a different system LSI, that is, a so-called reuse condition of reusing the basis array 2 will be described.

In the case of reusing the basic array 2, as shown in FIG. 8, it is necessary to obtain library data LD provided by the basis array 2 and share circuit design, manufacture environments and the like of the system LSI.

The library data LD includes layout pattern data of the basic array and device specification data. Examples of the device specification data are a logic simulation model for defining the operation of the basic array 2, LSI pattern information such as a layout, device information such as the characteristics of a MOS device and a layout rule, interface information such as various signal timings, and terminal information.

The library data LD is stored in a storage medium such as a CD-R (Compact Disc Recordable) or a magnetic tape by using a terminal such as a workstation or a personal computer and is distributed to the user.

On the user side, a system LSI according to the provided library data LD is manufactured, thereby enabling the basic array 2 to be reused in a different system LSI as shown in FIG. 9.

A form of releasing the library data LD in the basic array 2 will be described by referring to the flowchart of FIG. 10.

To development of an IP such as the basic array 2, as shown in an upper part of FIG. 10, the user such as a set maker, a silicon foundry for performing device development, fabrication, and the like, a library development company (hereinbelow, called EDA: Electronic Design Automation), and the like are related.

First, on the basis of needs of an SRAM or the like of the user, a foundry forms a concept of a memory IP. The concept of the memory IP and specifications (layout pattern rules, device information, and the like) of a device used for fabricating the memory IP by the foundry are provided to the EDA. The EDA develops a DA tool from the provided information. The foundry develops the memory by using the DA tool to generate a memory library.

The case of utilizing the developed IP will now be described.

In this stage, as shown in the lower part of FIG. 10, the user and the foundry are concerned and there is no communication with the EDA.

First, the user forms a concept of a semiconductor chip. The foundry selects a memory library adapted to the concept of the user from various memory libraries and provides it to the user.

When the memory library is provided, the user designs the logic by Verilog-HDL (Hardware Description Language) description, RTL (Register Transfer Level) description, or the like and verifies the logic by logic simulation or the like.

After the logic verification is finished, the foundry performs placement and routing in a semiconductor chip on the basis of the logic design of the user and manufactures a mask. By using the mask, the foundry manufactures a semiconductor chip and provides it to the user. The user assembles the provided semiconductor chip into a set.

Further, the basic array 2 provided as a memory library and a C (compiled) RAM (semiconductor integrated circuit device) 12 constructed by using the basic array 2 will be described by referring to FIG. 11.

Some kinds of layout patterns in each of which the memory capacity of the basic array 2 is preset are predetermined as shown in the left side of FIG. 11. In the logic simulation model, the decode signal, enable signal, monitor signal, and the like are preset.

In the layout pattern in the CRAM 12, as shown on the right side in FIG. 11, two or more basic arrays 2 and primitives 13 are combined. The primitives 13 are indirect peripheral circuits which are not provided for the basic array 2, interfaces, and the like. The logic simulation model of the CRAM 12 is equivalent to an interface such as a normally used synchronous SRAM.

FIG. 12 is a diagram showing an example of definition of a monitor signal terminal of a logic simulation model in the library data LD. FIG. 13 shows an example of description of the monitor signal M1.

FIGS. 12 and 13 show the examples of description in the case of using two basic arrays 21 and 22, which is conformed with a standard such as Verilog-HDL (Hardware Description Language).

FIG. 14 shows an example of wire connection of a memory module using the basis arrays 21 and 22 according to the logic simulation model in FIGS. 12 and 13.

The basic arrays 2₁ and 2₂ are connected to the interface 3 taking the form of a soft macro module. The interface 3 is provided with the decoding circuit, the latch circuit 8, and a selection control circuit 11.

The selection control circuit 11 selects either the basic array 2₁ or 2₂ to be activated on the basis of a command ck supplied. In the case of selecting the basic array 2₁, a control signal e0 is output to the basic array 2₁. In the case of selecting the basic array 2₂, a control signal e1 is output to the basic array 2₂.

The monitor signal M1 output from the basic arrays 2₁ and 2₂ is connected so as to be input to the latch circuit 8. Although not shown in FIG. 14, the monitor signal M2 output from the basic arrays 2₁ and 2₂ is also connected so as to be input to the latch circuit 8.

FIG. 15 shows signal waveforms in the memory module which is wire-connected as described above. FIG. 15 shows, in order from top to bottom, signal timings of the command ck for chip selection input to the selection control circuit 11, data q output from the latch circuit 7, the monitor signal M1 input to the latch circuit 8, the control signal e0 input to the basic array 21, the monitor signal M1 output from the basic array 21, data baq0 output from the basic array 21, the control signal e1 input to the basic array 22, the monitor signal M1 output from the basic array 22, and the data baq1 output from the basic array 22.

When the command ck is input to the selection control circuit 11 in the interface 3, the selection control circuit 11 outputs the control signal e0 (in the case where the basic array 21 is selected) on the basis of the command ck.

The basic array 21 is made active when the control signal e0 is received and outputs the data baq0 read from the basic array 21 to the latch circuit 8. The basic array 21 outputs the monitor signal M1 to the latch circuit 8. The latch circuit 8 receives the monitor signal M1 and outputs the latched data baq0.

According to the embodiment, since the interface 3 between the basic array 2 and the CPU core 10 takes the form of the soft macro module, the design of the interface 3 can be easily changed. Thus, the memory module 1 of high extensibility and high matching can be configured at low cost.

Since the layout pattern data and the device specification data of the basic array 2 is provided as the library data LD, the basic array 2 can be mounted on any system LSIs as long as the library data LD is common. Thus, the reusability of the basic array 2 can be increased, and a system LSI or the like can be constructed at low cost.

Although the invention achieved by the inventor herein has been concretely described on the basis of the preferred embodiment, obviously, the invention is not limited to the foregoing embodiment but can be variously changed without departing from the gist of the invention.

Effects obtained by representative inventions among the inventions disclosed in the specification will be described briefly hereinbelow.
(1) Since layout pattern data and device specification data of a basic array is provided as library data, the basic array 2 can be easily mounted also in a different semiconductor integrated circuit device. Thus, reusability of the basic array can be improved.
(2) Since an interface of a basic array can take the form of a soft macro module, change in the design of the interface is facilitated, and a memory module of high extensibility and high matching can be configured at low cost.
(3) From (1) and (2), a very reliable semiconductor integrated circuit device can be configured at low cost.

What is claimed is:

1. A computer readable storage medium storing a hard IP having layout pattern data of a basic array including a semiconductor memory and device specification data of said basic array.

2. The computer readable storage medium according to claim 1, wherein said device specification data includes a logic simulation model defining operation of said basic array, a layout pattern, device information, interface information, and terminal information.

3. The computer readable storage medium according to claim 2, wherein said basic array includes a storage circuit and direct peripheral circuits of said storage circuit, and a decoded signal is input to said direct peripheral circuits.

4. The computer readable storage medium according to claim 1, wherein said basic array operates asynchronously with a clock signal and has a monitor control unit for controlling an interface connected between said basic array and control means for controlling said basic array by a monitor signal.

5. The computer readable storage medium according to claim 4, wherein monitor signals output from said monitor control unit are constituted of a first monitor signal which is output in a reading operation from a read/write circuit provided to said direct peripheral circuit and a second monitor signal which is output in a reading operation from a word selection circuit provided to said direct peripheral circuit, and a latch circuit of said interface latches data on the basis of said first and second monitor signals.

6. A semiconductor integrated circuit device comprising:
two or more basic arrays each including a storage circuit and direct peripheral circuits of said storage circuit and taking the form of a hard IP; and
a primitive provided as an interface of each of said basic arrays.

7. The semiconductor integrated circuit device according to claim 6, wherein a decoded signal output from said primitive is input to said basic array.

8. The semiconductor integrated circuit device according to claim 6, wherein said basic array operates asynchronously with a clock signal and has a monitor control unit for controlling said primitive by a monitor signal.

9. The semiconductor integrated circuit device according to claim 8, wherein monitor signals output from said monitor control unit are constituted of a first monitor signal which is output in a reading operation from a read/write circuit provided to said direct peripheral circuit and a second monitor signal which is output in a reading operation from a word selection circuit provided to said direct peripheral circuit, and a latch circuit provided for said primitive latches data on the basis of said first and second monitor signals.
